(19) United States
(12) Patent Application Publication
(10) Pub. No.: US 2004/0193864 A1
(43) Pub. Date: Sep. 30, 2004

(54) System and method for actively booting a computer system

(76) Inventors: Chih Ming Tsai, Wugu Township (TW); Chien-Hsing Liu, Lujhu Township (TW); Cheng-Han Chang, Guanyin Shiang (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/780,934

(22) Filed: Feb. 17, 2004

(30) Foreign Application Priority Data
Mar. 25, 2003 (TW) 92106596

(51) Int. Cl. G06F 15/177

(52) U.S. Cl. 713/1

(57) ABSTRACT

A system and method for actively booting a computer system, according to the present invention, are capable of controlling a CPU of the computer system to selectively access boot codes from either an XIP type or non-XIP type memory devices attached in the computer system to initiate an operating system of the computer system.

### BACKGROUND OF THE INVENTION

1. Field of the Invention

The present invention relates to a system and method for booting a computer system, and in particular to a system and method capable of actively booting a computer system compatible with different type memory devices.

2. Description of the Related Art

A called “execute-in-place (XIP)” technology refers to a specific function provided with a storage device, which data or command codes stored in the storage device can be directly accessed by a central processing unit (CPU) in a computer system, without pass through a random access memory (RAM), thus reducing power consumption and data loss, and increasing executing speed.

Said storage devices, such as NOR-type flash memories, were popular and widely used at present. As known, flash memories comprise both NOR-type and NAND-type nonvolatile memories. The NAND-type nonvolatile memory, such as an electronic erasable programmable read-only memory (EEPROM), has advantages of lower cost per unit, higher performance, and easy update through an interface of a computer system. The advantages of NOR-type flash memories includes usage of lower voltage, faster randomly accessing speed, lower power consumption, and higher stability, in opposition that NAND-type memories have larger memory capacity, higher write-back speed, and smaller chip size.

The difference between NOR-type and NAND-type nonvolatile memories is that NOR-type nonvolatile memories are more suited of accommodating fewer codes and faster random access speed but NAND-type memories are more suited of high-density data recordation. Additionally, the primary feature of NOR-type flash memory is in use of XIP technology that applications stored in the memory can be directly accessed and executed without pass through a random access memorythereby being capable of providing higher transmission efficiency. Particularly in smaller memory capacity of approximate 1-4 M bytes, NOR-type flash memory has more cost effective but offers reduced performance due to lower writing and erasing speeds. NAND-type flash memory provides high-density data units for achieving high-density data recordation and faster writing and erasing speeds.

Furthermore, a NAND-type flash memory, with almost half size of a NOR-type flash memory, is less expensive than the NOR-type flash memory due to easier manufacturing process thereof. However, because of lacking the XIP function and needing specific controlling interface, NAND-type flash memory is more difficult to be applied as a storage device.

### SUMMARY OF THE INVENTION

Accordingly, an object of the present invention is to provide a system and method for actively booting a computer system, which allows a CPU of the computer system to be capable of selectively accessing required boot codes from either an XIP type flash memory or non-XIP type flash memory devices attached in the computer system thereby initiating an operating system of a computer system.

According to the object described above, the present invention provides a system for actively booting a computer system, comprising a non-XIP type storage medium controller, an internal buffer, and a multiplexing storage medium controller. A CPU disposed in a computer system accesses required boot codes from a storage medium thereof directly through the multiplexing storage medium controller to initiate an operating system of the computer system when said storage medium is found as an XIP type storage medium.

Oppositely, the multiplexing storage medium controller first disables the CPU when said storage medium is found as a non-XIP type storage medium. Next, the non-XIP type storage medium controller is facilitated by the multiplexing storage medium controller to access the boot codes from the non-XP type storage medium, and then to store the boot codes in the internal buffer. The multiplexing storage medium controller re-activates or re-enables the CPU when the non-XIP type storage medium controller accesses and stores the boot codes, successfully. The re-enabled CPU accesses the boot codes from the internal buffer through the multiplexing storage medium controller thereby initiating the operating system.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 illustrates a schematic diagram of the architecture of a system according to an embodiment of the present invention; and

FIG. 2 illustrates a flowchart for details of a method according to the present invention.

### DETAILED DESCRIPTION OF THE INVENTION

Accordingly, the present invention discloses a system and method for actively booting a computer system, capable of controlling a CPU of the computer system to alternatively and compatibly access required boot codes from either an XIP or a non-XIP type storage medium initiating an operating system of the computer system.

As aforementioned, a NOR-type flash memory is capable of executing codes directly but a NAND-type flash memory requires an extra input/output controlling (I/O) interface, and is thus much more complex than NOR-type flash memories.

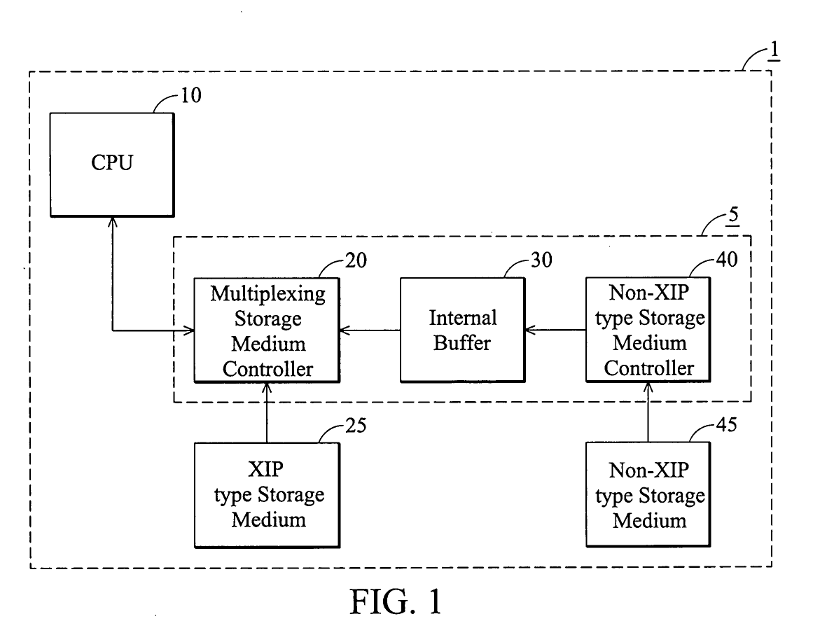

FIG. 1 illustrates a schematic diagram of the architecture of the system according to an embodiment of the present invention. Meanwhile, a computer system 1 comprises an actively booting system 5, a CPU 10, a XIP type storage medium 25, and a non-XIP type storage medium 45. The actively booting system 5 further comprises a multiplexing storage medium controller 20, an internal buffer 30, and a non-XIP type storage medium controller 40. The multiplexing storage medium controller 20 defines boot address mapping thereby accessing boot codes directly from the XIP type storage medium 25 or from the internal buffer 30 to the CPU 10. The Non-XIP type storage medium controller 40 is used to access the boot codes from non-XIP type storage medium 45 and then to store the boot codes in said internal buffer 30.

Description for action of actively booting system 5 is as follows. Multiplexing storage medium controller 20 determines whether the storage medium installed in the computer system 1 is an XIP type storage medium while computer system 1 is powered up. When said storage medium is found as XIP type storage medium 25, the CPU 10 accesses the boot codes directly from XIP type storage medium 25 through multiplexing storage medium controller 20 thereby initiating an operating system of computer system 1. Oppositely, the multiplexing storage medium controller 20 first disables CPU 10 when said storage medium is found as non-XIP type storage medium 45.

Next, non-XIP type storage medium controller 40 is facilitated by multiplexing storage medium controller 20 to access the boot codes from non-XIP type storage medium 45, and then to store the boot codes temporarily in internal buffer 30. When the non-XIP type storage medium controller 40 accesses and stores the boot codes successfully, the multiplexing storage medium controller 20 re-activates or re-enables the CPU 10 to access the boot codes from internal buffer 30 for initiating the operating system.

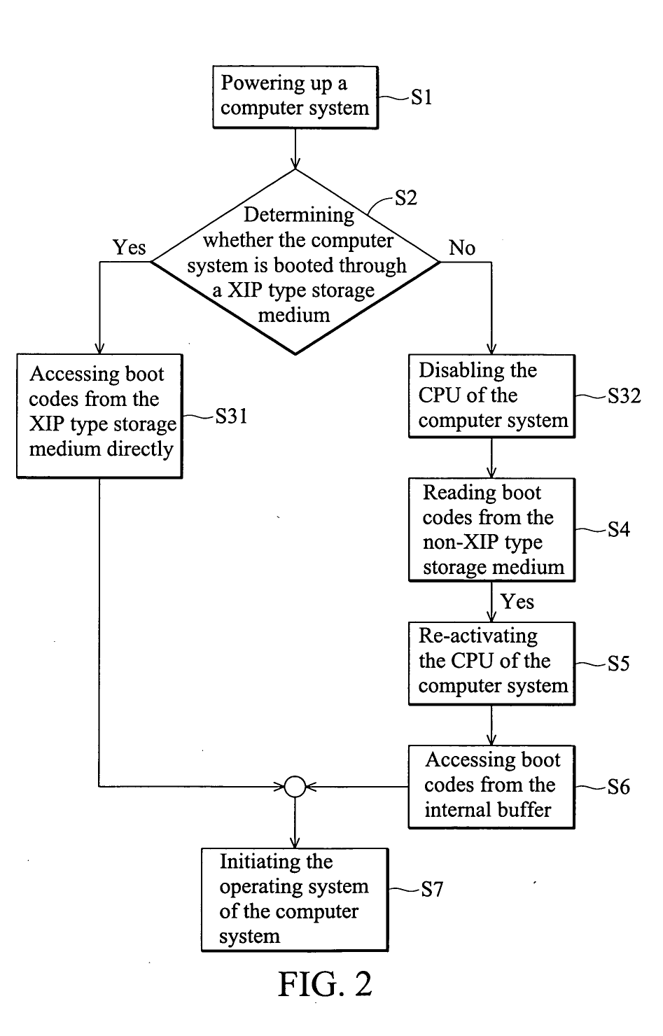

FIG. 2 illustrates a flowchart for details of the method according to the present invention as described below:

In step S1, a computer system is powered up.

In step S2, A multiplexing storage medium controller determines whether the computer system is directly booted through a XIP type storage medium or not, to decide which one type of storage medium is used to initiate an operating system of the computer system.

In step S31, a CPU disposed in the computer system accesses boot codes from the XIP type storage medium directly through the multiplexing storage medium controller to initiate the operating system when said storage medium for booting is found as a XIP type storage medium.

In step S32, the multiplexing storage medium controller first disables the CPU when said storage medium for booting is found as a non-XIP type storage medium.

In step S4, then a non-XIP type storage medium controller is facilitated to accesses the boot codes from the non-XIP type storage medium and stores the boot codes in an internal buffer.

In step S5, the multiplexing storage medium re-activates or re-enables the CPU after the boot codes have been stored in the internal buffer.

In step S6, the CPU accesses the boot codes from the internal buffer through the multiplexing storage medium controller.

In step S7, the CPU initiates the operating system in accordance with the boot codes.

The method of the present invention thus enables a computer system to be compatible with different type memory devices, such as XIP type memories including NOR-type flash memories and read-only memories, or non-XIP type memories including NAND-type flash memories, serial EEPROMS, and parallel EEPROMS, for initiating an operating system.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for actively booting a computer system, electrically connected with a storage medium which stores boot codes thereon for initiating an operating system of the computer system, and said system comprising:
a non-XIP type storage medium controller accessing the boot codes from the storage medium when said storage medium is a non-XIP type storage medium;
an internal buffer coupled to the non-XIP type storage medium controller, storing the boot codes accessed from the non-XIP type storage medium; and
a multiplexing storage medium controller coupled to the internal buffer, controlling a central processing unit (CPU) disposed in the computer system to access the boot codes from the internal buffer to initiate the operating system of the computer system.

2. The system as claimed in claim 1 wherein the multiplexing storage medium controller disables the CPU before the non-XIP type storage medium controller accesses the boot codes.

3. The system as claimed in claim 2 wherein the multiplexing storage medium controller re-activates the CPU when the non-XIP type storage medium controller accesses and stores the boot codes successfully from the non-XIP type storage medium.

4. The system as claimed in claim 1 wherein the multiplexing storage medium controller accesses the boot codes directly from the storage medium to the CPU for initiating the operating system when said storage medium is an XIP type storage medium.

5. The system as claimed in claim 1 wherein the non-XIP type storage medium is a NAND-type flash memory.

6. A method for actively booting a computer system, with access of boot codes from a storage medium to initiate an operating system of a computer system, comprising steps of:
determining whether the storage medium is a XIP type storage medium;
a CPU disposed in the computer system directly accessing the boot codes directly from the storage medium through a multiplexing storage medium controller when said storage medium is the XIP type storage medium;
facilitating a non-XIP type storage medium controller to access the boot codes from the storage medium and then to store the boot codes in an internal buffer, and controlling the CPU to access the boot codes from the internal buffer when said storage medium is a non-XIP type storage medium; and
the CPU implementing the boot codes to initiate the operating system of the computer system.

7. The method as claimed in claim 6 wherein the step of controlling the CPU further comprising: disabling the CPU by the multiplexing storage medium controller before the non-XIP type storage medium controller accesses the boot codes from the storage medium when said storage medium is a non-XIP type storage medium.

8. The method as claimed in claim 7 wherein the step of controlling the CPU further comprising: re-activating the CPU when the non-XIP type storage medium controller accesses and stores the boot codes successfully from the storage medium.

9. The method as claimed in claim 6 wherein the non-XIP type storage medium is a NAND-type flash memory.

10. A computer system providing a method for actively enabling the computer system, and said method comprising the steps of:
determining whether the storage medium is a XIP type storage medium;
a CPU disposed in the computer system accessing the codes directly from the storage medium through a multiplexing storage medium controller when said storage medium is a XIP type storage medium;
facilitating a non-XIP type storage medium controller to access the codes from the storage medium and then to store the codes in an internal buffer, and controlling the CPU to access the codes from the internal buffer when said storage medium is a non-XIP type storage medium; and
the CPU implementing the accessed codes in the computer system.

11. The method as claimed in claim 10 wherein the multiplexing storage medium controller disables the CPU before the non-XIP type storage medium controller accesses the codes from the storage medium when said storage medium is a non-XIP type storage medium.

12. The method as claimed in claim 10 wherein the multiplexing storage medium controller re-activates the CPU when the non-XIP type storage medium controller accesses and stores the codes successfully from the storage medium.

13. The method as claimed in claim 10 wherein the non-XIP type storage medium is a NAND-type flash memory.
